(19) United States
(12) Patent Application Publication
(10) Pub. No.: US 2003/0182851 A1
(43) Pub. Date: Oct. 2, 2003

(54) Foldable garden frame

(76) Inventor: Chen-Hsiung Lin, Taichung (TW)

Correspondence Address: Chen-Hsiung Lin, 58, MA YUAN WEST ST., TAICHUNG, TW

(21) Appl. No.: 10/112,901

(22) Filed: Mar. 29, 2002

(51) Int. Cl. A01G 13/00

(52) U.S. Cl. 47/2

(57) ABSTRACT

A foldable garden frame has a first main rod, a second main rod, a first end rod, and a second end rod. The first main rod and the second main rod are connected pivotally. The first main rod and the first end rod are connected pivotally. The second main rod and the second end rod are connected pivotally.

### BACKGROUND OF THE INVENTION

The present invention relates to a foldable garden frame. More particularly, the present invention relates to a foldable garden frame which will be folded into a compact configuration.

Referring to FIG. 5, a conventional garden frame 10 is made of metal. However, the conventional garden frame 10 cannot be folded. Then a plurality of conventional garden frames will occupy a large room while the conventional garden frames are overlapped together.

### SUMMARY OF THE INVENTION

An object of the present invention is to provide a foldable garden frame which will be folded into a compact configuration. Then a plurality of folded garden frames will be overlapped together.

Accordingly, a foldable garden frame comprises a first main rod, a second main rod, a first end rod, and a second end rod. The first main rod and the second main rod are connected pivotally. The first main rod and the first end rod are connected pivotally. The second main rod and the second end rod are connected pivotally.

### BRIEF DESCRIPTION OF THE DRAWINGS

FIG. 1 is a schematic view illustrating an application of a plurality of foldable garden frames of a preferred embodiment in accordance with the present invention;

FIG. 2 is a perspective view of a foldable garden frame of a preferred embodiment while the foldable garden frame is folded;

FIG. 2A is a schematic view illustrating a connection of a first main rod and a second main rod while the first main rod and the second main rod are folded;

FIG. 2B is a schematic view illustrating a connection of a first main rod and a first end rod while the first main rod and the first end rod are folded and a connection of a second main rod and a second end rod while the second main rod and the second end rod are folded;

FIG. 3 is an elevational view of a foldable garden frame of a preferred embodiment in accordance with the present invention;

FIG. 3A is a perspective schematic view illustrating a connection of a first main rod and a second main rod while the first main rod and the second main rod are extended;

FIG. 3B is a sectional schematic view illustrating a connection of a first main rod and a second main rod while the first main rod and the second main rod are extended;

FIG. 4 is an elevational view of a foldable garden frame of a preferred embodiment while the foldable garden frame is extended;

FIG. 4A is a perspective schematic view illustrating a connection of a first main rod and a first end rod while the first main rod and the first end rod are extended;

FIG. 4B is a sectional schematic view illustrating a connection of a first main rod and a first end rod while the first main rod and the first end rod are extended; and

FIG. 5 is an elevational view of a conventional garden frame of the prior art.

### DETAILED DESCRIPTION OF THE INVENTION

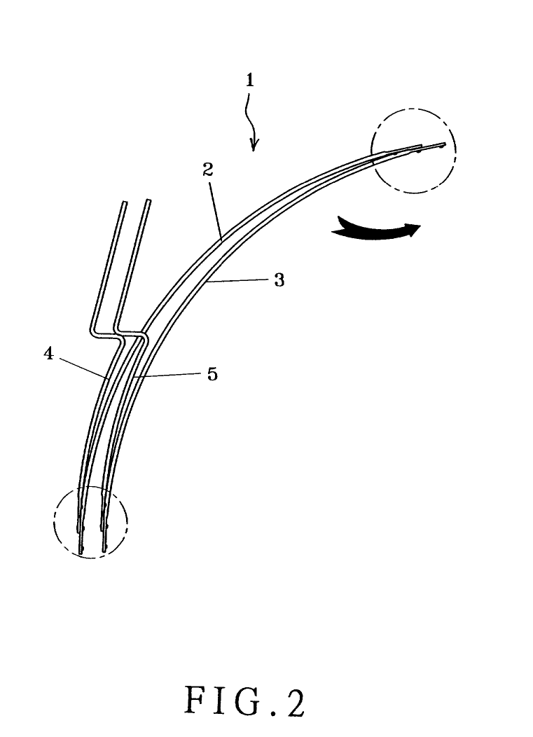

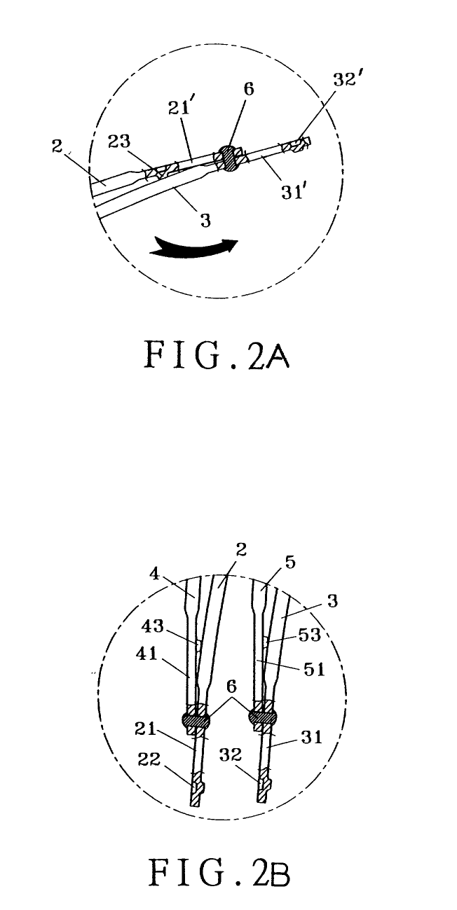

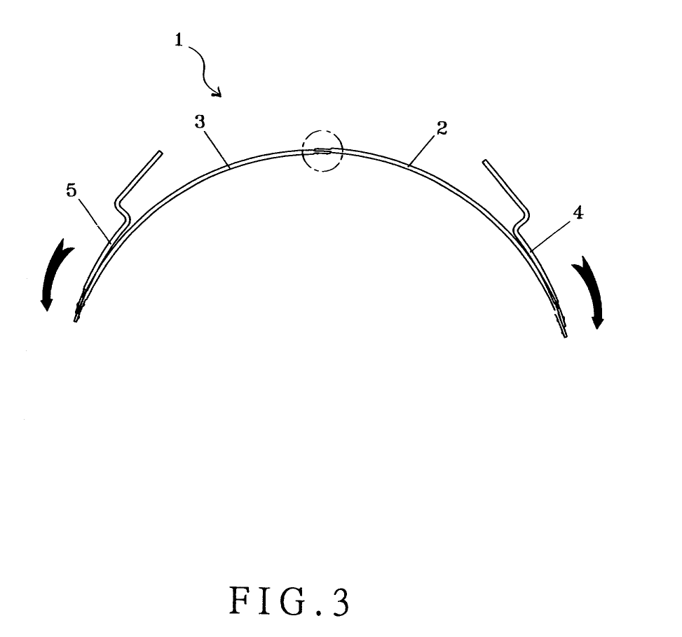

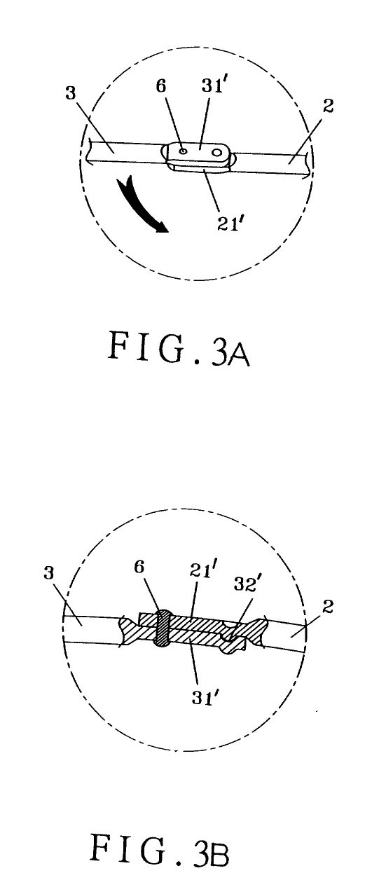

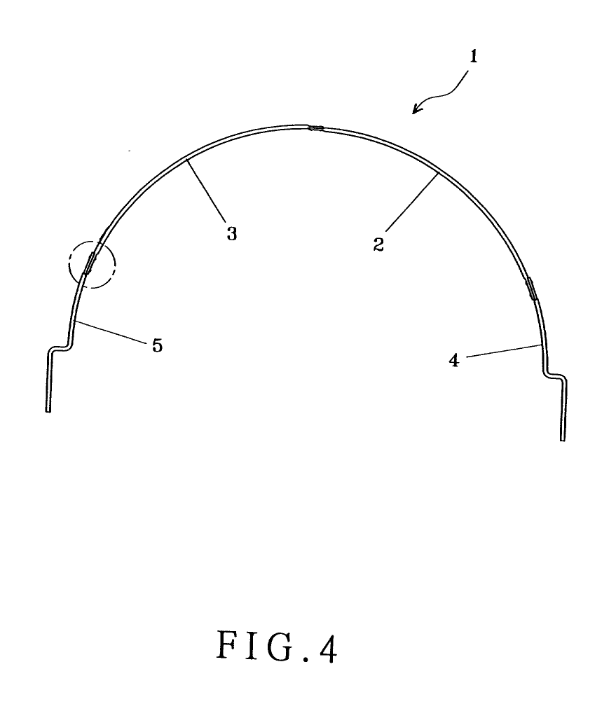

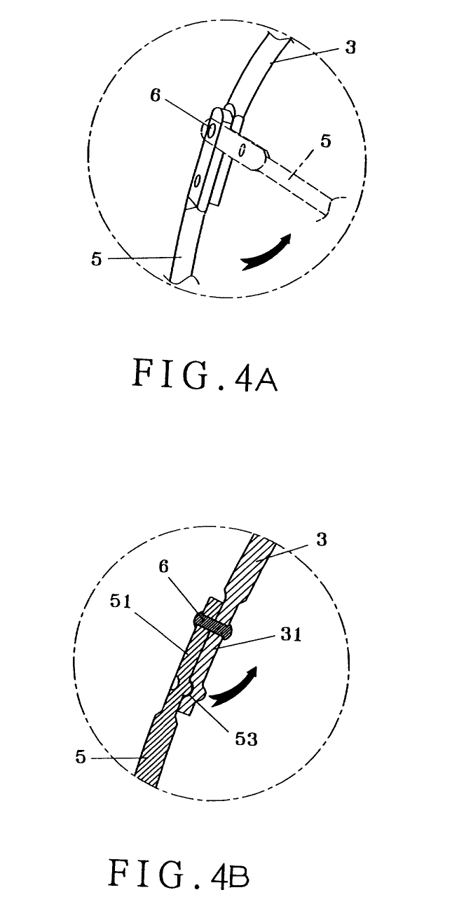

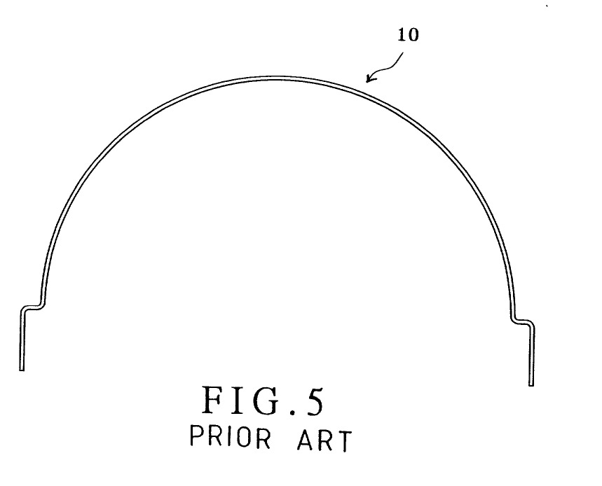

Referring to FIGS. 2 to 4, a foldable garden frame 1 comprises a first main rod 2, a second main rod 3, a first end rod 4, and a second end rod 5.

The first main rod 2 and the second main rod 3 are connected pivotally.

The first main rod 2 and the first end rod 4 are connected pivotally.

The second main rod 3 and the second end rod 5 are connected pivotally.

The first main rod 2 has a first connection end 21 having a recess 22, and a second connection end 21′ having a protruded block 23.

The second main rod 3 has a first end portion 31 having a first groove 32, and a second end portion 31′ having a second groove 32′.

The first end rod 4 has a proximal connection portion 41 having a protruded post 43.

The second end rod 5 has a proximal connector 51 having a protrusion 53.

The first main rod 2 and the second main rod 3 are fastened by a rivet 6.

The first main rod 2 and the first end rod 4 are fastened by a rivet 6.

The second main rod 3 and the second end rod 5 are fastened by a rivet 6.

When the foldable garden frame 1 is extended, the protrusion 53 of the second end rod 5 is inserted in the first groove 32 of the second main rod 3. The protruded post 43 of the first end rod 4 is inserted in the recess 22 of the first main rod 2. The protruded block 23 of the first main rod 2 is inserted in the second groove 32′ of the second main rod 3.

Referring to FIG. 2, the foldable garden frame 1 is folded into a compact configuration.

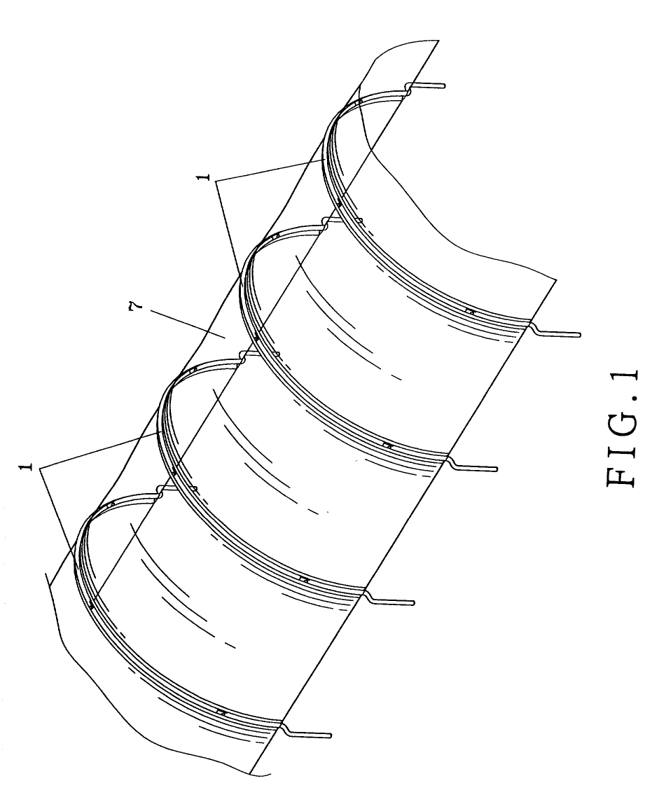

Referring to FIG. 1, a canopy 7 encloses a plurality of foldable garden frames 1.

Then a plurality of folded garden frames will be overlapped together.

The present invention is not limited to the above embodiment but various modification thereof may be made. Furthermore, various changes in form and detail may be made without departing from the scope of the present invention.

I claim:

1. A foldable garden frame comprises:
a first main rod, a second main rod, a first end rod, and a second end rod,
the first main rod and the second main rod connected pivotally,
the first main rod and the first end rod connected pivotally, and
the second main rod and the second end rod connected pivotally.

2. The foldable garden frame as claimed in claim 1, wherein the first main rod has a first connection end having a recess, and a second connection end having a protruded block.

3. The foldable garden frame as claimed in claim 1, wherein the second main rod has a first end portion having a first groove, and a second end portion having a second groove.

4. The foldable garden frame as claimed in claim 1, wherein the first end rod has a proximal connection portion having a protruded post.

5. The foldable garden frame as claimed in claim 1, wherein the second end rod has a proximal connector having a protrusion.
